(19) United States
(12) Patent Application Publication
(10) Pub. No.: US 2007/0213485 A1
(43) Pub. Date: Sep. 13, 2007

(54) Ionic Liquids As Supports

(76) Inventors: Olivier Lavastre, Gahard (FR); Fabien Bonnette, Bressuire (FR); Abbas Razavi, Mons (BE)

Correspondence Address: FINA TECHNOLOGY INC, PO BOX 674412, HOUSTON, TX, 77267-4412, US

(21) Appl. No.: 10/573,901

(22) PCT Filed: Sep. 23, 2004
(86) PCT No.: PCT/EP04/52292

§ 371 Date: Jan. 16, 2007

(30) Foreign Application Priority Data
Sep. 29, 2003 (FR) 03 11392

(51) Int. Cl. C08F 4/44

(52) U.S. Cl. 526/161; 526/172; 526/348; 502/200

(57) ABSTRACT

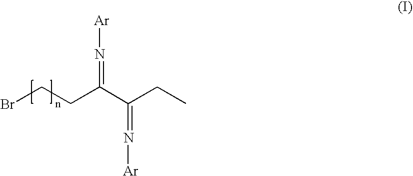

The present invention discloses a method for preparing a supported catalyst component comprising the steps of: a) providing a halogenated bisimine precursor component of formula (I); b) reacting the halogenated bisimine precursor with an ionic liquid precursor in a solvent to prepare an ionic liquid; c) reacting the ionic liquid prepared in step b) with a metallic complex of formula (II) L₂MY₂; wherein L is a labile ligand, M is a metal selected from Ni or Pd and Y is a halogen; d) retrieving a single site catalyst component dissolved in an ionic liquid. It also discloses an active catalyst system dissolved in an ionic liquid and its use in the polymerisation of olefins.

The present invention relates to the use of ionic liquids to prepare supported catalyst components for olefin polymerisation.

Ionic liquids have been described in literature such as for example in U.S. Pat. No. 5,994,602, or in WO96118459 or in WO01/81353. They disclose various methods for preparing ionic liquids and various applications.

These applications comprise oligomarisation of ethene, propene or butene with various nickel-based precursors dissolved in ionic liquids as disclosed for example in Dupont et al. (Dupont, J., de Souza R. F., Suarez P. A. Z., in Chem. Rev., 102, 3667, 2002.). The same document also discloses that Ziegler-Natta type polymerisation can be carried out in dialkylimidazolium halides/ammonium halide ionic liquids using AlCl₃₋ₓRₓ, as cocatalysts.

Other applications include the use of ionic liquids that are liquid at or below room temperature as solvents for transition-metal-mediated catalysis, such as described for example in Welton (Welton T., in Chem. Rev., 99, 2071, 1999.). Most attempts have proven successful in dimerisation or oligomerisation, but polymerisation remains problematic, especially with single site catalyst components.

There is thus a need to develop new single site catalyst systems based on ionic liquids that are active in the polymerisation of alpha-olefins.

It is an aim of the present invention to provide a method for preparing a single site catalyst component supported on an ionic liquid.

It is another aim of the present invention to provide a single site catalyst component supported on an ionic liquid.

It is a further aim of the present invention to provide a process for polymerising alphaolefins using such supported single site catalyst component.

It is also an aim of the present invention to prepare new polymers with said new catalyst system.

Accordingly, the present invention discloses a method for preparing a supported single site catalyst component for the polymerisation of alpha-olefins that comprises the steps of:
a) providing a halogenated bisimine precursor component of formula (I) 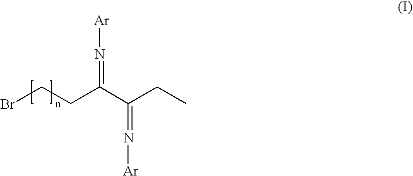
b) reacting the halogenated bisimine precursor with an ionic liquid precursor in a solvent to prepare an ionic liquid;
c) reacting the ionic liquid obtained in step b) with a metallic precursor of formula (II) in a solvent
   L₂MY₂ (II)
   wherein L is a labile ligand, M is a metal selected from Ni or Pd and Y is a halogen;
d) retrieving a supported single site catalyst component.

The halogenated bisimine precursor is obtained by reacting
a bisimine of formula III 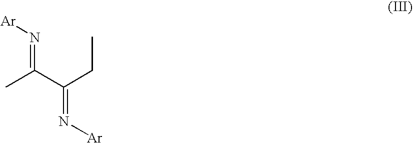
   wherein each Ar can be the same or different and is a substituted or unsubstituted benzene ring Bz-R, wherein R is hydrogen or an alkyl having from 1 to 12 carbon atoms. The benzene ring is preferably substituted in positions 2 and 6, and the preferred substituents are methyl, ethyl, isopropyl
with lithium diisopropylamide or lithium tert-butylate at a temperature of from −78 to −10° C., preferably at a temperature of about −30° C. and for a period of time of from 30 minutes to 3 hours and preferably of from 30 minutes to 1 hour;
and then with a compound of formula IV 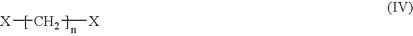
   wherein X is a halogen and n is an integer of from 2 to 12, preferably from 5 to 8 and more preferably equal to 6, at a temperature of from −78 to −10° C. up, and then slowly returning to room temperature (about 25° C.) for a period of time of from 30 minutes to 16 hours, preferably of about one hour.

All reactions are carried under argon at atmospheric pressure, using the standard Schlenk or glovebox techniques.

The resulting halogenated bisimine is represented by formula I.

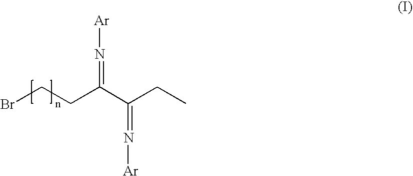

The halogenated bisimine is then reacted with an ionic liquid precursor, preferably N-alkylimidazole or pyridine, in a solvent such as tetrahydrofuran (THF), CH₂Cl₂ or CH₃CN or without solvent.

In the ionic liquid, the anion X⁻ can be selected from Cl⁻, Br⁻, I⁻, BF₄⁻, PF₆⁻, AsF₆⁻, SbF₆⁻; NO₂⁻ and NO₃⁻. It can also be selected from compounds of formula AlR_{4-z}X″_{z} wherein R can be selected from an alkyl having from 1 to 12 carbon atoms, substituted or unsubstituted, or from a cycloalkyl having 5 or 6 carbon atoms, substituted or unsubstituted, or from an heteroalkyl, substituted or unsubstituted, or from an heterocycloalkyl, substituted or unsubstituted, or from an aryl having 5 or 6 carbon atoms, substituted or unsubstituted, or from an heteroaryl, substituted or unsubstituted, or from an alkoxy, an aryloxy, an acyl, a silyl, a boryl, a phosphino, an amino, a thio or a seleno, wherein X″ is a halogen and wherein z is an integer from 0 to 4. The cationic part of the ionic liquid may be prepared by protonation or alkylation of a compound selected from imidazolium, pyrazoline, thiazole, triazole, pyrrole, indone, tetrazole, pyridine, pyrimidine, pyrazine, pyridazine, piperazine or piperidine.

Preferably, the anion X⁻ is Br⁻ or BF₄⁻, and preferably the cationic part is derived from imidazolium or pyridinium, and the ionic liquid precursor is thus preferably N-alkylimidazole or pyridine.

If the ionic liquid precursor is N-alkyl-imidazolium, the reaction is carried out at a temperature of from 50 to 80° C., preferably of from 60 to 70° C. and for a period of time of from 1 to 24 hours, preferably of from 4 to 6 hours. The resulting intermediate product is an ion pair of formula V.

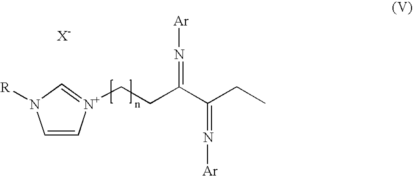

If the ionic liquid precursor is pyridinium, the reaction is carried out at a temperature of from 20 to 80° C., preferably of from 50 to 70° C. and for a period of time of from 1 to 5 days, preferably of about 3 days. The resulting product is an ion pair of formula VI

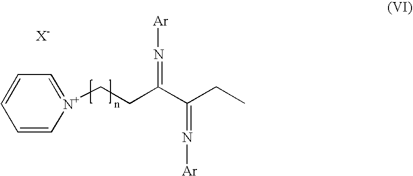

The intermediate product V or VI is then reacted with a metallic complex of formula L₂MY₂ in a solvent selected typically from CH₂Cl₂, THF, or CH₃CN, at room temperature (about 25° C.), for a period of time of from 1 to 24 hours, preferably of from 14 to 18 hours. The resulting product is an ion pair representing a supported catalytic component of formula VIII if the ionic liquid is a N-alkyl-imidazolium 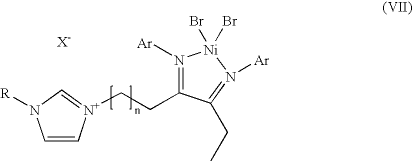
or of formula VIII if the ionic liquid is pyridinium 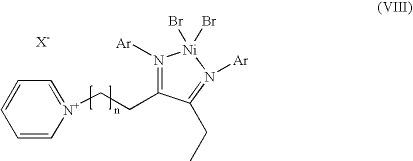
wherein M, Ar and Y are as defined here-above.

Optionally, before the reaction with the metallic complex is carried out, the intermediate product (VI) or (VII) can be reacted with a salt C⁺A⁻, wherein C⁺ is a cation that can be selected from K⁺, Na⁺, NH₄⁺, and A⁻ is an anion that can be selected from PF₆⁻, SbF₆⁻, BF₄⁻, (CF₃—SO₂)₂N⁻, ClO₄⁻, CF₃SO₃⁻, NO₃⁻ or CF₃CO₂⁻. The reaction is carried out in a solvent selected typically from CH₂Cl₂, THF or CH₃CN at a temperature of from 50 to 80° C., preferably of about 60° C. and for a period of time of from 6 to 48 hours, preferably of from 16 to 24 hours.

The reaction with the metallic complex is then carried out as previously leading to an ion pair representing a supported catalytic component of formula IX if the ionic liquid precursor is N-alkyl-imidazolium 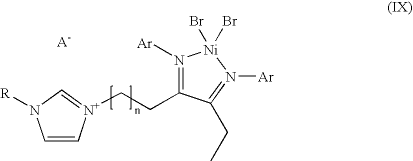
or of formula X if the ionic liquid precursor is pyridinium

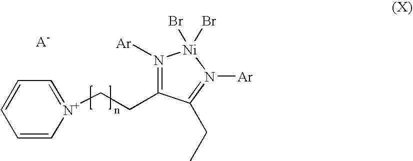

The present invention also discloses a catalytic component supported on an ionic liquid, obtainable by the method described here-above.

An active supported catalyst system is then obtained by addition of an activating agent.

The activating agent can be selected from alumoxanes or aluminium alkyls or boron-based activating agents.

The aluminium alkyls are of the formula AlR_{X} and can be used wherein each R is the same or different and is selected from halides or from alkoxy or alkyl groups having from 1 to 12 carbon atoms and x is from 1 to 3. Especially suitable aluminiumalkyl are dialkylaluminum chloride, the most preferred being diethylaluminum chloride (Et₂AlCl).

The preferred alumoxanes comprise oligomeric linear and/or cyclic alkyl alumoxanes represented by the formula: 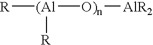
and 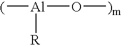
for oligomeric, cyclic alumoxanes,
wherein n is 1-40, preferably 10-20, m is 3-40, preferably 3-20 and R is a C₁-C₈ alkyl group and preferably methyl.

Methylalumoxane (MAO) is preferably used.

Suitable boron-based activating agents may comprise triphenylcarbenium boronate such as tetrakis-pentafluorophenyl-borato-triphenylcarbenium [C(Ph)₃⁺B(C₆F₅)₄⁻] as described in EP-A-0,427,696

Other suitable boron-containing activating agents are described in EP-A-0,277,004.

The amount of activating agent is such that the Al/M ratio is of from 100 to 1000.

The present invention further provides a method for homopolymerising or for copolymerising alpha-olefins that comprises the steps of:
a) injecting the catalytic component supported on an ionic liquid, an a polar solvent and the activating agent into the reactor;
b) injecting the monomer and optional comonomer into the reactor;
c) maintaining under polymerisation conditions;
d) retrieving the polymer under the form of chips or blocks.

The conditions of temperature and pressure for the polymerisation process are not particularly limited.

The pressure in the reactor can vary from 0.5 to 50 bars, preferably from 1 to 20 bars and most preferably from 4 to 10 bars.

The polymerisation temperature can range from 10 to 100° C., preferably from 20 to 50° C. and most preferably at room temperature (about 25° C.).

The solvent is a polar and is typically selected from an alkane, preferably n-heptane.

The reaction is carried out for a period of time of from 30 minutes to 24 hours.

The polymer obtained according to the present invention is typically obtained as a mixture of chips and blocks, wherein the amount of blocks is predominant. The chips have a size of from 0.5 to 5 mm and the blocks have a size of from 5 mm to 5 cm, preferably of about 1 cm. The amount of chips is typically less than 25 wt %, based on the total weight of the polymer, preferably less than 15 wt %.

The monomer that can be used in the present invention are alpha-olefins having from 3 to 8 carbon atoms and ethylene, preferably ethylene and propylene.

### LIST OF FIGURES

FIG. 1 represents the ethylene consumption expressed in mL as a function of time expressed in minutes for catalyst systems based on imidazolium and respectively on BF₄⁻ or on Br⁻ counter-anion.

FIG. 2 represents the ethylene consumption expressed in mL as a function of time expressed in minutes for catalyst systems based respectively on pyridinium and imidazolium.

### EXAMPLES

All reactions were carried out on a vacuum line under argon using standard glovebox and Schlenk techniques.

Synthesis of supported catalyst components using different ionic liquids.

Synthesis of Halogenated Bisimine (1).

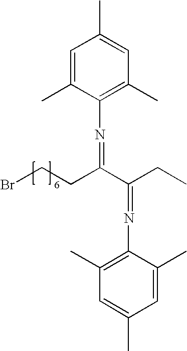

For preparing a preliminary solution of lithium diisopropyl amide (LDA) 0.41 mL of butyllithium (1.6 molar in hexane) were added to 0.101 mL (0.72 mmoles) of isopropylamine in THF at a temperature of −35° C. In a Shlenk tube under argon, 155 mg (0.46 mmoles) of bisimine were introduced in 5 mL of THF and then cooled to a temperature of −35° C. The solution of LDA was then added dropwise at a temperature of −35° C. and stirred for 30 minutes until the reaction mixture turned red. That solution was syringed into a solution of 0.184 mL (1.19 mmoles) of 1-6 dibromohexane that was cooled to a temperature of −35° C. and the resulting mixture was stirred for 1 hour at a temperature of −35° C. and then for 16 hours at room temperature. The THF was evaporated and 5 mL were added to form a white precipitate. It was filtered and the filtrate was concentrated into yellow oil. A column on silica gel with a gradient of pentane to pentane/toluene (80/20) as eluent was carried out to retrieve 220 mg of yellow oil with a yield of 95%.

¹H and ¹³C NMR carried out on the product gave the following results:

¹H NMR (200 MHz, CDCl₃) δ: 6.88 (s, 4), 3.33 (tr, 2), 2.53 (q, 2), 2.49 (tr, 2), 2.28 (s, 6), 2.01 (s, 12), 1.76 (q, 2), 1.47 (m, 2), 1.25 (m, 6), 1.02 (tr, 3).

¹³C NMR (50 MHz, CDCl₃) δ: 172.22, 171.07, 145.82, 132.25, 128.66, 124.62, 33.81, 32.72, 29.71, 29.06, 28.23, 27.66, 26.41, 22.34, 20.71, 18.17, 11.20.

Synthesis of Bisimine (3).

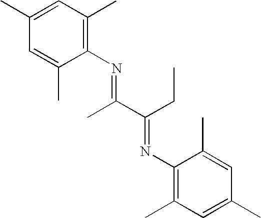

In a solution of 40 mL of dichloromethane, 0.628 mL (6 mmoles) of 2-5 pentanedione and 5.86 mL (42 mmoles) of 2,4,6 trimethylaniline were added and cooled down to a temperature of −20° C. A solution of 0.59 mL (7.1 mmoles) of TiCl₄ was added dropwise at a temperature of −20° C. and then stirred for 30 minutes at −20° C., until the reaction mixture turned red. The mixture was brought back to room temperature and stirred for 5 days. The dichloromethane was evaporated and 120 mL of diethylic ether were added to form a precipitate. After filtering, the filtrate was concentrated into a brown solid that washed with 20 mL of methanol in order to retrieve 1.575 g of yellow powder with a yield of 78.5%.

¹H and ¹³C NMR carried out on the product gave the following results:

¹H NMR (200 MHz, CDCl₃) δ: 6.86 (s, 4), 2.50 (q, 2), 2.26 (s, 6), 1.99 (s, 15), 1.00 (tr, 3).

¹³C NMR (50 MHz, CDCl₃) δ: 172.73, 145.67, 132.41, 128.64, 124.55, 22.21, 20.77, 17.95, 16.36, 11.44.

Ion pair (5).

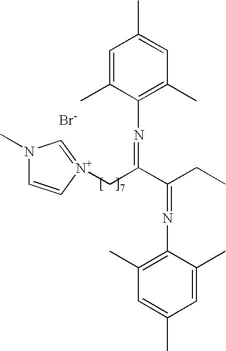

In a Schlenk tube under argon, 5 mL of THF were introduced followed by 100 mg (0.201 mmoles) of the halogenated bisimine(I). 0.032 mL (0.402 mmoles) of N-methylimidazole were then added. The reaction medium was refluxed at 66° C. for 5 hours and then at room temperature for 16 hours. It was then concentrated under vacuum to produce yellow oil that washed three times with 3 mL of diethylic ether to yield a powder. That powder was dissolved in 1 mL of dichloromethane and then precipitated in 25 mL of pentane. The precipitate was filtered then evaporated under vacuum to prepare 107 mg of yellow powder with a yield of 95%.

¹H and ¹³C NMR carried out on the product gave the following results:

¹H NMR (200 MHz, CDCl₃) δ: 10.56 (s, 1), 7.22 (tr, 1), 7.10 (tr, 1), 6.68 (s,4), 4.20 (tr, 2), 4.08 (s, 3), 2.51 (q, 2), 2.47 (tr, 2), 2.39 (s, 6), 1.99 (s, 12), 1.80 (m, 2), 1.43 (m, 2), 1.20 (m, 6), 1.00 (tr, 3).

¹³C NMR (50 MHz, CDCl₃) δ: 172.7, 171.2, 146.11, 132.73, 129.11, 124.96, 123.47, 121.85, 55.79, 37.2, 30.66, 29.95, 29.42, 28.75, 26.71, 26.39, 22.77, 21.19, 18.60, 11.68.

Ion pair (6).

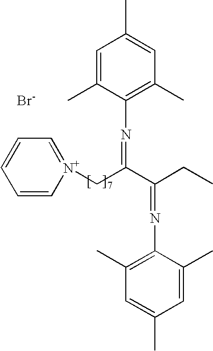

In a Schlenk tube under argon 45 mg (0.09 mmoles) of the halogenated bisimine (1) were added followed by 2 mL of pyridine as solvent. The solution was stirred at 90° C. for 15 hours. The pyridine was then evaporated and the residue washed 3 times with 5 mL of diethylic ether. It was dissolved in 1 mL of dichloromethane, and then precipitated with 20 mL of pentane. The precipitate was filtered and dried to produce 24 mg of yellow powder with a yield of 45%.

¹H NMR carried out on the product gave the following results:

¹H NMR (200 MHz, CDCl₃) δ: 9.37 (d, 2), 8.43 (tr, 1), 8.03 (tr, 2), 6.85 (s, 4), 4.86 (tr, 2), 2.48 (q, 2), 2.40 (tr, 2), 2.24 (s, 6), 1.96 (s, 12), 1.90 (m, 2), 1.38 (m, 2), 1.18 (m, 8), 0.85 (tr, 3).

Synthesis of Catalyst (7).

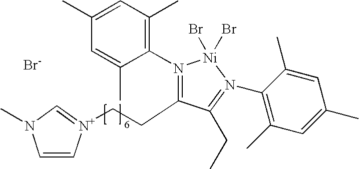

In a Schlenk tube under argon, 15 mL of dichloromethane were introduced followed by 30 mg (0.052 mmoles) of the ion pair (5). 14.3 mg (0.046 mmoles) of (DME)NiBr₂ were then added and the mixture was stirred during 16 hours at room temperature until it turned orange. The dichloromethane was evaporated to produce a brown oil. The oil is dissolved in 1 mL of dichloromethane and then precipitated with 7 mL of pentane. The precipitate was filtered and dried to produce 31 mg of brown powder with a yield of 75%.

Synthesis of Catalyst (8).

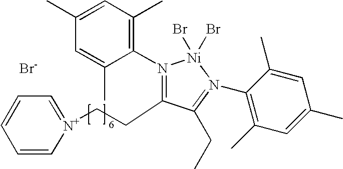

20 mg (0.035 mmoles) of the ion pair (6) were introduced under argon and 2 mL of dichloromethane were then added. This was followed by the addition of 12.84 mg (0.0416 mmoles) of (DME)NiBr₂ and the mixture was stirred for 16 hours at room temperature. The solvent was evaporated and the residue washed with 5 mL of diethylether. It was then dissolved in 5 mL of acetone to form a precipitate. The precipitate was filtered and dried to produce 14 mg of orange powder with a yield of 51%.

Synthesis of Catalyst (9).

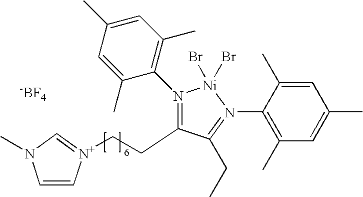

In a Schlenk tube under argon, 45 mg (0.068 mmoles) of bisimine-imidazolium (BF₄⁻) were introduced followed by 5 mL of dichloromethane. 25.25 mg (0.081 mmoles) of (DME)NiBr₂ were then added and the mixture was stirred for 16 hours at room temperature. The solvent was evaporated and the residue washed twice with 20 mL of diethylether. It was then dissolved in 5 mL of acetone to form a precipitate. The precipitate was filtered and dried to produce 50 mg of red powder with a yield of 91%.

Polymerisation of Ethylene.

The polymerisation conditions were the same for all for all examples and they were as follows:
5 μmoles of catalyst component were dissolved in 60 ml of n-heptane;
300 mole-equivalents of methylaluminoxane (MAO) were added;
T=25° C.;
p=4 bars,
t=2 hours
the polymer is treated with acid methanol (10 vol % HCl).

The polymerisation results are displayed in Table I.

TABLE I

| | mass PE | Tf | Activity | | |
|---|---|---|---|---|---|
| Catalyst | mg | ° C. | kgPE/mol/hr | Nature PE | % chips |
| 7 | 4144 | 131.2 | 476 | blocks/chips | 14 |
| 9 | 8207 | 129.5 | 1266 | blocks/chips | 26 |
| 8 | 10442 | 129.4 | 1642 | blocks/chips | 9 |

The use of ionic liquids as support allows the preparation of precipitates that are easy to inject into the reactor.

As can be seen in Table I, the polymers are mostly obtained under the shape of blocks that are much safer and easier to handle than small size polymeric particles. It has also been observed that the fusion temperature of the polyethylene is comparable to that obtained with other catalyst systems, as w ell as the molecular weight and the polydispersity.

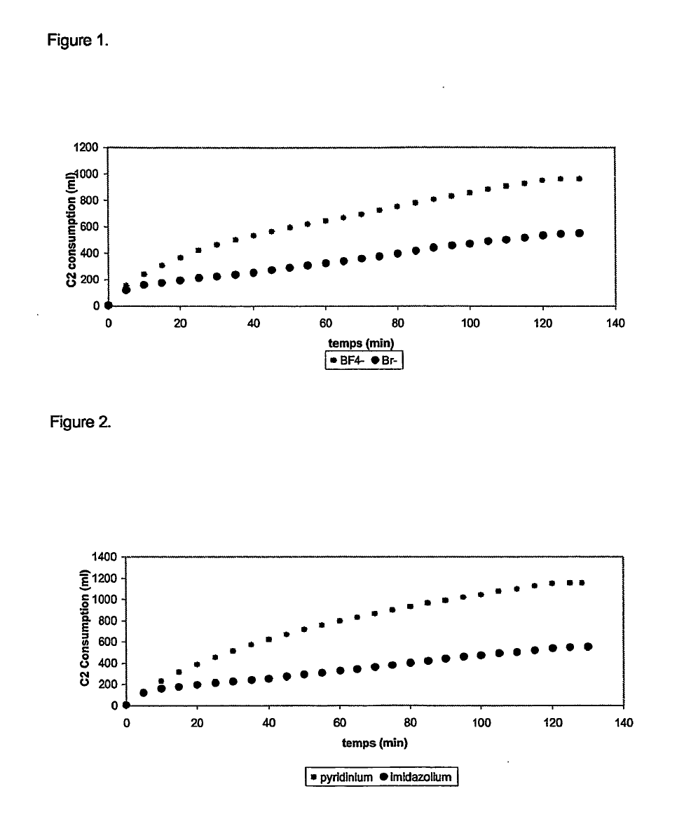

The nature of the counter-anion has a significant influence on the activity of the catalyst system as can be seen in FIG. 1 representing the consumption of ethylene expressed in ml as a function of time expressed in minutes respectively for Br⁻ and for BF₄⁻. The catalyst system based on the BF₄⁻ counter-anion has a much larger consumption of ethylene and thus a much larger activity than that based on the B⁻ counter-anion.

The nature of the cation also plays a significant role in the activity of the catalyst system as can be seen in FIG. 2 representing the consumption of ethylene expressed in mL as a function of time expressed in minutes respectively for pyridinium- and imidazilium-based ionic liquids. The catalyst system based on the pyridinium-type ionic liquid has a much larger consumption of ethylene and thus a much larger activity than that based on the imidazolium-type ionic liquid.

1. A method for preparing a supported catalyst component comprising the steps of:
a) providing a halogenated bisimine precursor component of formula (I) 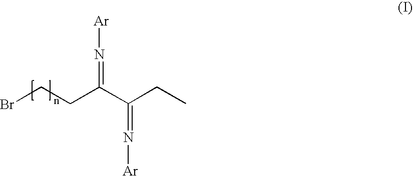
b) reacting the halogenated bisimine precursor with an ionic liquid precursor in a solvent to prepare an ionic liquid;
c) reacting the ionic liquid prepared in step b) with a metallic precursor of formula (II)
L₂MY₂ (II)
wherein L is a labile ligand, M is a metal selected from Ni or Pd and Y is a halogen
d) retrieving a supported single site catalyst component.

2. The method of claim 1 wherein the ionic liquid precursor is N-alkyl-imidazolium or pyridinium.

3. The method of claim 1 or claim 2 wherein between step b) and step c), the reaction product of step b) is reacted with an ionic compound C⁺A⁻, wherein C⁺ is a cation selected from K⁺, Na⁺, NH₄⁺, and A⁻ is an anion selected from PF₆⁻, SbF₆⁻, BF₄⁻, (CF₃—SO₂)₂N⁻, ClO4⁻, CF₃SO₃⁻, NO₃⁻ or CF₃CO₂⁻.

4. The method of any one of the preceding claims wherein the solvent used in steps b) and step c) is selected from THF, CH₂Cl₂ or CH₃CN.

5. A catalyst component supported on an ionic liquid obtainable by the method of any one of claims 1 to 4.

6. A catalyst system supported on an ionic liquid comprising the catalyst component of claim 5 and an activating agent.

7. The catalyst system supported on an ionic liquid of claim 6 wherein the activating agent is methylaluminoxane.

8. The catalyst system supported on an ionic liquid of claim 7 wherein the amount of methylaluminoxane is such that the Al/M ratio is of from 100 to 1000.

9. A method for homopolymerising or copolymerising alpha-olefins that comprises the steps of:
a) injecting the catalytic system supported on an ionic liquid of any one of claims 6 to 8 with an apolar solvent into the reactor;
b) injecting the monomer and optional comonomer into the reactor;
c) maintaining under polymerisation conditions;
d) retrieving the polymer under the form of chips or blocks.

10. The method of claim 9 wherein the apolar solvent is n-heptane.

11. The method of claim 9 or claim 10 wherein the monomer is ethylene or propylene.

12. A polymer under the shape of chips and blocks obtainable by the process of any one of claims 9 to 11.

13. The polymer of claim 12 wherein the amount of c hips is of less than 25 wt %, based on the total weight of the polymer.

14. A method for the preparation of a supported catalyst component comprising:
a) providing a halogenated bisimine precursor characterized by the formula 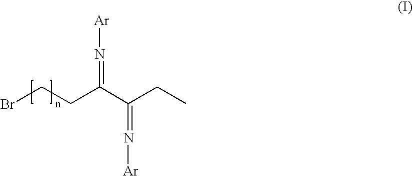
wherein each Ar is the same or different and is independently a phenyl group or a substituted phenyl group having from 1 to 3 alkyl substituents;
b) reacting said halogenated bisimine precursor with an ionic liquid precursor in a solvent to prepare an ionic liquid;
c) reacting said ionic liquid with a metallocene precursor characterized by the formula
L₂MY₂ (II)
wherein L is a labile ligand, M is a nickel or palladium, and Y is a halogen; and
d) recovering a supported single site catalyst component from the reaction of subparagraph c).

15. The method of claim 14 wherein each Ar is a alkyl substituted phenyl group having from 1-3 alkyl substituents selected from the group consisting of methyl, ethyl, and isopropyl groups.

16. The method of claim 15 wherein each of said phenyl groups has substituents at the 2 and 3 positions.

17. The method of claim 15 wherein each of said substituted phenyl groups has substituents at the 2, 4 and 6 positions.

18. The method of claim 17 wherein each of said substituted phenyl groups is a 2,4,6 trimethyl phenyl group.

19. The method of claim 14 wherein the ionic liquid precursor is an N-alkyl-imidazole or pyridine.

20. The method of claim 14 further comprising prior to subparagraph c) reacting said ionic liquid with an ionic compound characterized by the formula C⁺A⁻, wherein C⁺ is a cation selected from the group consisting of K⁺, Na⁺, NH₄⁺, and A⁻ is an anion selected from the group consisting of PF₆⁻, SbF₆′ BF₄⁻, (CF₃—SO₂)₂N⁻, ClO₄⁻, CF₃SO₃⁻, NO₃⁻ and CF₃CO₂⁻.

21. The method of claim 14 wherein said solvent is selected from a group consisting of tetrahydrofuran, methylene dichloride, and acetonitrile.

22. A method for the preparation of an alpha olefin polymer comprising:
a) providing a catalyst system comprising a supported single site catalyst component produced by the process of claim 14 and an activating agent for said catalyst component;
b) introducing said catalyst system in an apolar solvent and an alpha olefin monomer into a polymerization reactor,
c) operating said reactor under polymerization conditions; and
d) recovering an alpha olefin polymer product from said reactor.

23. The method of claim 22 wherein said alpha olefin monomer comprises ethylene or propylene.

24. The method of claim 23 wherein said apolar solvent is n-heptane.

25. The method of claim 23 wherein said activating agent is methylalumoxane and wherein the polymer product recovered from said polymerization reactor is in the form of chips and blocks.

26. The process of claim 25 wherein the polymer product recovered from said reactor contains chips in an amount of less than 25 weight percent of the total weight of the polymer.

27. The method of claim 25 wherein said methylalumoxane is employed in an amount to provide a ratio of aluminum to the metal M within the range of 100-1,000.

28. The method of claim 25 wherein the polymer product recovered from said polymerization reactor comprises a mixture of chips having a particle size of from 0.5-5 mm and blocks having a size from 5 mm to 5 cm wherein the amount of chips in said polymer product is less than 25 weight percent.

29. The method of claim 28 wherein the amount of chips in said polymer product is less than 15 weight percent.

30. A catalyst component supported on an ionic liquid produced by the process of claim 14.

31. A catalyst system comprising the catalyst component of claim 30 and an activating agent.

32. The catalyst system of claim 31 wherein said activating agent is methylalumoxane.
